(19) United States
(12) Patent Application Publication
(10) Pub. No.: US 2004/0226020 A1
(43) Pub. Date: Nov. 11, 2004

(54) Method and system for using general and appliance operating systems in a single information handling device

(75) Inventor: Blair B.A. Birmingham, Toronto (CA)

Correspondence Address: TOLER & LARSON & ABEL L.L.P., 5000 PLAZA ON THE LAKE STE 265, AUSTIN, TX, 78746, US

(73) Assignee: ATI Technologies, Inc.

(21) Appl. No.: 10/869,165

(22) Filed: Jun. 16, 2004

Related U.S. Application Data
(63) Continuation of application No. 09/675,033, filed on Sep. 28, 2000.

(51) Int. Cl. G06F 9/00

(52) U.S. Cl. 719/310

(57) ABSTRACT

A method, system and computer readable medium are described for using multiple operating systems in a single information handling device. A general operating system and at least one appliance operating system can be executed by the same information handling device. The general operating system is loaded from a mass storage device, and is used for handling most general tasks required of an information handling device. The appliance operating system is loaded from non-volatile memory and is designed for specially running a single appliance, or set of appliances, independent of the general operating system. A user can selectively switch between available operating systems.

### CROSS-REFERENCE TO RELATED APPLICATION(S)

The present application claims priority from U.S. patent application No. 09/675,033, filed Sep. 28, 2000, entitled “METHOD. AND SYSTEM FOR USING GENERAL AND APPLIANCE OPERATING SYSTEMS IN A SINGLE INFORMATION HANDLING DEVICE (AS AMENDED),” naming inventor Blair B. A. Birmingham, which application is incorporated by reference herein in its entirety.

### BACKGROUND OF THE INVENTION

1. Field of the invention

The present invention relates generally to information handling systems and more particularly to using multiple operating systems within a single information handling system.

2. Description of Related Art

While computers were once built with specific tasks in mind, the adoption of computers by the general public has led to a requirement for computers to perform a wide variety of general tasks. With the convergence of TV and the Internet, the general trend has been to make a single computer capable of implementing almost any task, including home finance, web browsing, television tuning, compact disk playing and digital video disk playing; however, integrating all this functionality into a single computer system can be problematic.

To handle the wide variety of tasks in which computers are used, a single operating system is used to implement all tasks. To be able to control all the tasks required of it, the operating system must load separate computer applications and system drivers into the computer. While using a single operating system allows computers to perform the required tasks, the computer system can be slow to respond. The operating system can take several minutes to load all the system parameters it needs to handle general computing. For example, a user trying to play a compact disk must wait for the computer to load the appropriate system drivers for the compact disk drive and the appropriate application to control the drive, as well as software components unrelated to the compact disk. This can be a very time consuming process for a general operating system with extended functionality.

A computer system trying to handle multiple tasks can also become unstable (a common complaint expressed by many operating system users), leading to degraded performance. Furthermore, a computer accessing a hard drive often produces unwanted noise which can disturb a computer user attempting to listen to a compact disk or watch a movie. Given the problems discussed, it is apparent that currently available single-operating system computers are less than perfect.

### BRIEF DESCRIPTION OF THE DRAWINGS

Other objects, advantages, features and characteristics of the present invention, as well as methods, operation and functions of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a block diagram of an information handling system with a plurality of integrated operating systems and components, according to one embodiment of the present invention;

FIG. 2 is a flow chart illustrating a method for switching between multiple operating systems, according to at least one embodiment of the present invention; and

FIG. 3 is a diagram illustrating a method of selecting system controls and multiple operating systems.

### DETAILED DESCRIPTION OF THE DRAWINGS

At least one embodiment of the present invention provides a method for handling a plurality of tasks using a single information handling device. As described in greater detail below, the method comprises providing a plurality of operating systems on the single information handling device. The plurality of operating systems includes an appliance operating system, capable of controlling the information handling device to operate an appliance, and a general operating system, capable of performing the general information handling tasks. The method further includes executing the appliance operating system to control an appliance independent of the general operating system and executing the general operating system to control the information handling device to perform general information handling tasks. An advantage of at least one embodiment of the present invention is that specialized tasks can be performed faster. Another advantage of at least one embodiment of the present invention is that costs can be reduced by eliminating the need for redundant hardware.

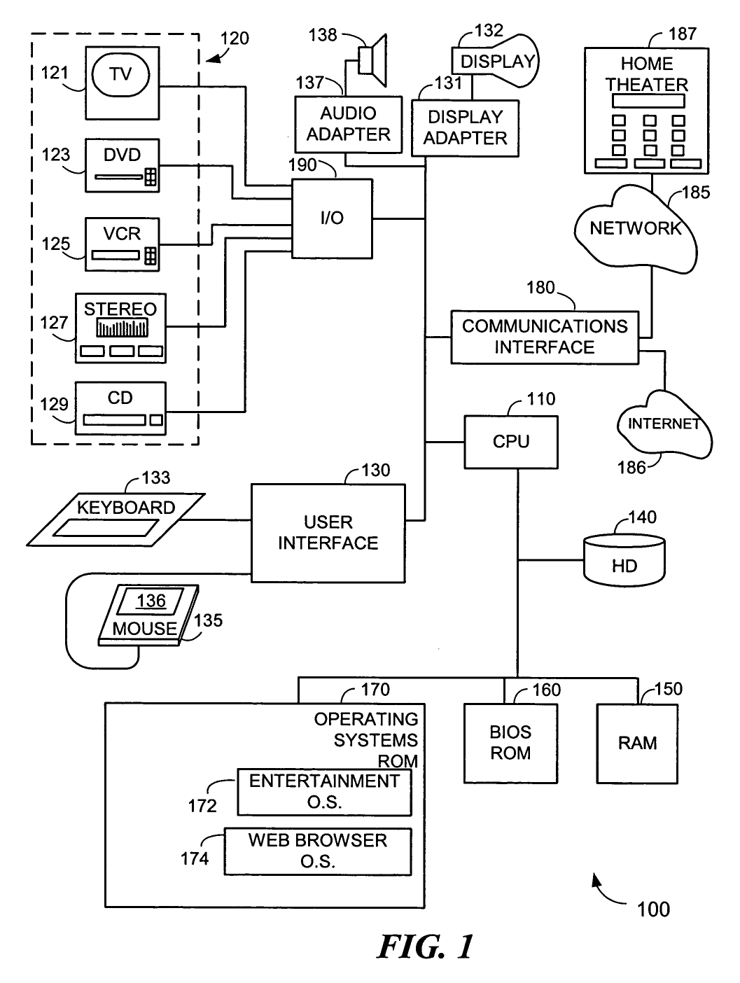

Referring now to FIG. 1, an information handling device 100 is shown with integrated appliances and appliance operating systems, according to one embodiment of the present invention. A plurality of appliance operating systems, such as entertainment operating system 172 and web browser operating system 174, are loaded from non-volatile memory, such as the appliance operating system read-only memory (ROM) 170 located in information handling device 100. Entertainment operating system 172 and web browser operating system 174 control information handling device 100 to perform specific tasks related to media handling devices 120 and navigating network 185 (through communication interface 180), respectively. In at least one embodiment, entertainment operating system 172 controls a plurality of appliances, such as media handling devices 120. In other embodiments, a separate appliance operating system is provided for each appliance to be controlled.

Communication interface 180 can be an electrical interface such as a universal serial bus (USB), small computer communication interface (SCSI), serial, or parallel interface. Alternatively, communication interface 180 can be a wireless interface such as infrared (IR), radio, or other wireless interface. Input/output (I/O) port and communication interface 180 are shown to illustrate two specific embodiments of a general communications interface. Two networks, Network 185 and Internet 186 are illustrated as two specific examples of networks that can be used in conjunction with various embodiments of the present invention. Network 185 is an example of a local area network (LAN), such a home network comprising a collection of networked appliances, like home theater system 187. Internet 186 is an example of a wide area network (WAN) such as the Internet, or another network of distributed computing devices.

A general operating system located in a mass storage device, such as hard drive 140 of information handling device 100, controls general purpose computing tasks, such as running application programs, as needed. In addition to hard drive 140, mass storage devices may include devices such as tape drives, compact disks (CD), digital video disks (DVD) and the like.

A user can select an operating system for a particular task. Central processing unit (CPU) 110, which is a data processor in at least one embodiment of the present invention, loads the selected processing system onto information handling device 100. Generally, CPU 110 is instructed by an appliance operating system to enable only the components of information handling device 100 that are needed for the tasks desired. For example, if audio adapter 137 and speaker 138 are not needed to operate a particular appliance, then audio drivers for audio adapter 137 are not loaded. Selection of an appropriate operating system can be done by directly accessing and configuring the Basic Input/Output System (BIOS) ROM 160 located in information handling device 100. Other methods of selecting an operating system include, but are not limited to, depressing a specific sequence of one or more buttons and/or keys on keyboard 133, setting one or more specific switches (not shown) integrated into information handling device 100, sending commands via network 185, or making selections on display 132 with mouse 135. Furthermore, an operating system to operate a specific appliance, such as one of the media handling devices 120, can be selected by pressing a button on the specific appliance.

When an operating system is selected, display 132 can be used through display adapter 131 to monitor the specific tasks chosen. Control of specific appliances such as CD player 129 or another of the media handling devices 120, and tasks such as browsing network 185, can be performed through user interface 130 with keyboard 133 or mouse button 136 on mouse 135. System settings and/or variables may be stored in random access memory (RAM) 150 for the duration of time during which an operating system is running. These system settings and variables can be used to facilitate changing from one operating system to another, and to aid in preventing conflicts when more than one operating system is being executed concurrently.

Entertainment operating system 172 can be selected for controlling one or more of the media handling devices 120 with CPU 110 in information handling device 100. Entertainment operating system 172 is loaded to enable only the components of information handling device 100 that are needed for controlling the selected media handling devices 120. In at least one embodiment, entertainment operating system 172 controls a single appliance, and additional operating systems (not illustrated) are used to control other appliances, while in other embodiments entertainment operating system 172 controls more than one appliance.

When entertainment operating system 172 is executed from ROM 170, hard drive 140 can be shut down or placed in standby mode. With hard drive 140 inoperative, noise and heat generally produced by a mass storage device, such as hard drive 140, can be reduced or eliminated. As previously discussed, settings or variables needed for running entertainment operating system 172 can be stored in random access memory (RAM) 150. Once entertainment operating system 172 is running, the user can select control settings for media handling devices 120 through information handling device 100.

In one embodiment, the appliances under the control of information handling system 100, running entertainment operating system 172, are home theater system 187, connected via network 185, and media handling devices 120 which include, but are not limited to, a television 121, a digital video disk (DVD) player 123, a video cassette recorder 125, a stereo system 127 and a compact disk (CD) player 129. One or more of the media handling devices 120 may be included as part of information handling system 100. In some embodiments, duplicate information handling systems may be connected to information handling system 100. For example, information handling system 100 may include a built in CD player, and home theater 187 may include a second CD player. In one embodiment, entertainment operating system 172 can control either the built in CD player, or the second CD player that is part of home theater 187, while a general operating system would be limited to controlling the built in CD player. In other embodiments, entertainment operating system 172 cannot control the built in CD player.

Control for television 121 can include, but is not limited to, display settings, video/audio input control and channel settings. Furthermore, television 121 can be a separate component under the control of information handling device 100, or an integrated unit of information handling device 100, such as a television tuner card integrated for use with display adapter 131. DVD player 123 and CD player 129 can also be integrated units of information handling device 100, being controlled through specialized drivers built into entertainment operating system 172 or through direct hardware controls from information handling device 100. Settings for the appliances, such as media handling devices 120 and home theater system 187, can be controlled through the use of keyboard 133 or mouse 135, with or without the use of display 132 for monitoring the settings.

The appliances can be integrated with communications interface 180, such as home theater system 187, connected to network 185. In an alternative embodiment, home theater system 187 is connected to information handling system 100 via a dedicated communications interface like input/output (I/O) system 190. Home theater system 187 can be a networked audio receiver or collection of receivers that adjust audio speakers within the user's home. When it is desired to shut down entertainment operating system 172, media handling devices 120 can be placed powered down or placed in a power-saving mode to conserve power. If it is no longer desired for entertainment operating system 172 to run, entertainment operating system 172 can be shutdown, removing any stored instructions left on RAM 150 and disabling currently running processes. Other appliances under the control of an operating system, such as entertainment operating system 172 can include consumer appliances such as refrigerators, home ovens, cloths washers, home security systems networked in a user's home, and the like.

If a user selects to use information handling device 100 for web browsing, web browser operating system 174 can be executed through CPU 110. Web browser operating system 174 can load only the system drivers necessary for browsing network 185, such as system drivers related to communicating through network interface 180. User interface 130 can be enabled for allowing the user to browse network 185 with selections made through keyboard 133 and mouse 135. The content of the web browser can be shown on display 132 through display adapter 131. When web browser operating system 174 is no longer desired, web browser operating system 174 can be shut down, removing all settings made to information handling device 100.

Despite the addition of quick-loading appliance specific operating systems, such as appliance operating system ROMs 170, a general operating system can be stored in a mass storage device, such as hard drive 140. If a user needs to control a separate appliance, or needs to perform other tasks, not covered by appliance operating system ROMs 170, the user can select to run a general operating system. BIOS ROM 160 can be set to use CPU 110 to execute the general operating system.

The general operating system, preferably located in hard drive 140, includes device drivers for running general purpose applications designed for the general operating system on information handling device 100. Unlike appliance specific operating systems ROMs 170, the general operating system can take several minutes to load. The general operating system is designed to meet most of the tasks required of information handling device 100, and commands CPU 110 to load drivers for controlling all the components of information handling device 100. Execution of commands for controlling devices on information handling device 100 is performed through applications running on top of the general operating system. The applications are loaded from sets of instructions on RAM 150 or hard drive 140, with CPU 110. The general operating system then commands CPU 110 to perform the functions defined by the applications.

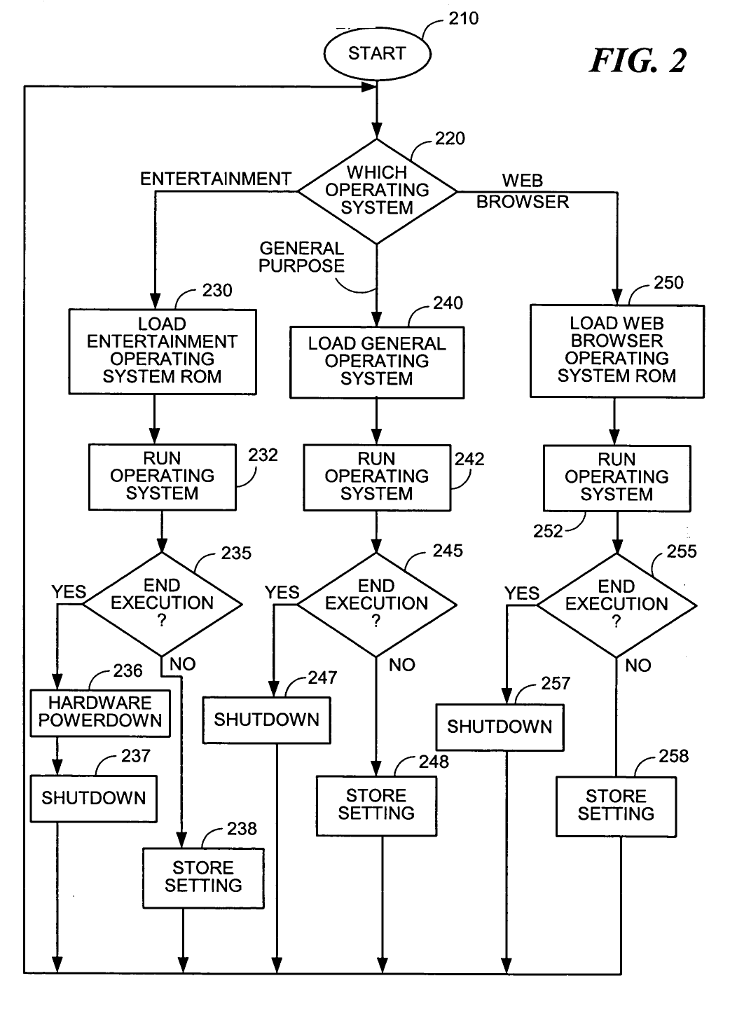

Referring now to FIG. 2, a flow chart diagram illustrating a method of executing and switching between multiple operating systems is shown, according to at least one embodiment of the present invention. A user chooses between multiple operating systems to execute specific tasks. When the user no longer desires to run the selected operating system, the user can select to shut down or switch to a different operating system.

The method is initiated by the desire of a user to use information handling device 100 for a particular task in step 210. In step 220, the user selects the operating system desired. Selection of the operating system includes, but is not limited to, pressing a specific sequence of buttons and/or keys on keyboard 133 (FIG. 1), setting specific switches integrated into information handling device 100, or making selections on display 132 (FIG. 1), for example with a mouse 135 (FIG. 1).

If the user selects to run the entertainment operating system, the entertainment operating system 172 is loaded, as in step 230. In at least one embodiment, at the time entertainment operating system 172 is loaded, a check is performed to determine the current state of information handling system 100. Part of the check includes a resource allocation check to determine if entertainment operating system 172 can be loaded without any resource conflicts. If conflicts between entertainment operating system 172 and a currently running operating system, the two operating systems can negotiate for use of the potentially conflicted resources. Such negotiations may result in the currently running operating system surrendering control of the resources, or shared control of the resources. Alternatively, the currently running system may maintain control of the conflicted resources, and allow entertainment operating system 172 to use the resources on a request basis. Various suitable methods of negotiating for resource control can be implemented consistent with the objects of the present invention.

Since, in at least one embodiment, entertainment operating system 172 is loaded from read-only memory (ROM), entertainment operating system 172 can be loaded quickly, as compared to loading general operating systems from hard drive 140 (FIG. 1). Appliance specific drivers are loaded for controlling media handling devices 120 (FIG.

1). Applications can also be loaded to run on top of the selected operating system for handling specific tasks. Generally, only necessary components of information handling device 100 are loaded, such as I/O interface 190 (FIG. 1) or communications interface 180 (FIG. 1).

In step 232, CPU 110 (FIG. 1) uses the loaded components for running entertainment operating system 172. In step 235, when the user either desires to no longer run entertainment operating system 172 (FIG. 1) or needs to load another operating system, the user can be given the option of still running the hardware while the other operating system runs, or to shutdown the operating system completely; however, devices which conflict with components to be run on another operating system in information handling device 100 may be disabled before the new operating system is loaded.

In step 238, the user selects to allow media handling devices 120 to run, storing the settings for entertainment operating system 172 before entertainment operating system 172 is shutdown, thereby allowing information handling system 100 to switch to a different operating system without upsetting the current settings of entertainment operating system 172. In step 236, media handling devices 120 are preferably powered down or placed in a power-saving or standby mode, halting hardware operations and storing the settings of media handling devices 120 in special sections of RAM 150 or hard drive 140. In step 237, entertainment handling system 172 is shutdown. The loaded drivers are removed from information handling device 100.

If the user selects to browse the web, web browser operating system 174 can be loaded, as in step 250. As previously discussed in relationship to entertainment operating system 172, when web browser operating system 174 is loaded, a conflict check may be performed to determine the current state of information handling system 100. Web browser operating system 174 loads the drivers needed for communications over network 185 (FIG. 1), such as communications interface 180 (FIG. 1). Web browser operating system 174 can also load device drivers for allowing the user to view and interact with the networked information, such as user interface 130 (FIG. 1) and display adapter 131 (FIG. 1). Web browsing applications can also be loaded. The web browsing applications work on top of web browser operating system 174, acting as in interface between the user and the operating system.

In step 252, web browser operating system 250 is executed by CPU 110 to provide the user with a web browser. In step 255 the user can choose to end the execution of web browser operating system 174 or to select another operating system with web browser 174 running concurrently. In step 258, the user selects to run another operating system concurrently and the settings of web browser 174 are stored while the selected operating system is loaded by CPU 110. As previously discussed, if the selected operating system also makes use of the devices under the current control of operating system 174, the devices may become disabled, at least temporarily, and the new operating system can be given priority over the resources of information handling device 100. In step 257, web browsing operating system 174 is shut down, allowing information handling device 100 to be powered down or to load a new operating system.

If the user desires to use information handling device 100 for an application not covered by appliance operating system ROMs 170, the user can select to load the general operating system, as in step 240. As previously discussed in relation to entertainment operating system 172, at the time a general operating system is loaded, a conflict check may be performed to determine the current state of information handling system 100. The general operating system is preferably loaded from a mass storage device, like hard drive 140. To run most applications information handling device 100 may encounter, the general operating system loads device drivers for most of the components of information handling device 100. In step 242, CPU 110 runs the general operating system. In general, applications are used to control components of information handling device 100. In step 245, the user can shut down the general operating system or switch to another operating system. If the user selects to shut down the operating system, CPU 110 ends all currently running processes and ends the execution of the general processing system, as in step 247. In step 248, the current instructions running in the general operating system are halted and critical information may be stored to allow information handling system 100 to switch to another operating system.

It will be appreciated that FIG. 2 illustrates a specific embodiment in accordance with the present invention, and the other specific embodiments would be anticipated by the disclosure herein. For example, in accordance with the method of FIG. 2 there is not an operating system running at the time a specific application is selected for operation. In an alternate embodiment, when a specific application is selected, such as control of a DVD player, the method can first determine if a current operating system is running that is capable of operating the DVD. If such an operating system is running, control of the application can be transferred to that operating system. If such an operating system is not running, a new operating system capable of operating the application can be loaded as previously described. As such, it may be possible for a specific application to operate under more than one operating system. Given an option, an application will generally be controlled by the operating system that is most efficient for its application. For example, if both a general purpose operating system and a specialized peripheral operating system are currently operating, peripherals will generally operate under the peripheral operating system when possible. This will help to isolate the application from issues which may arise that are related to the general purpose operating system. In addition, the general purpose operating system can be shut down without effecting the application specific operating system.

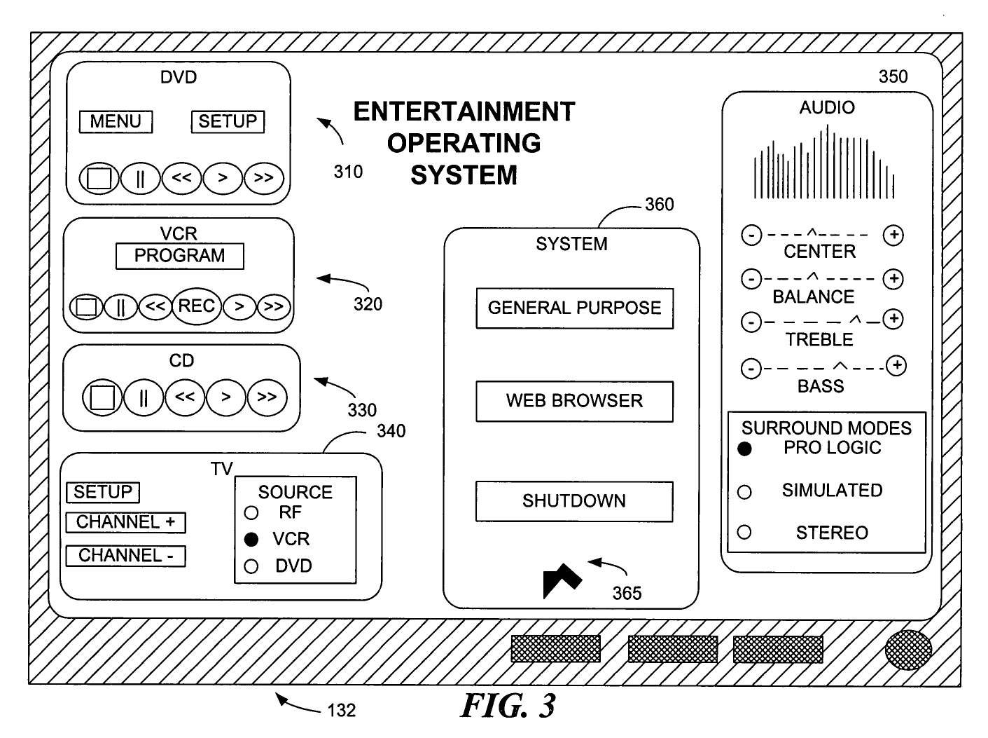

Referring now to FIG. 3, a method of allowing a user to select to switch between operating systems is shown, according to one embodiment of the present invention. Display 132 is used to allow a user to monitor and select controls and changes for media handling devices 120 (FIG. 1). The user selects controls by controlling the movement of pointer 365 on display 132 using mouse 135 (FIG. 1) with button 136 (FIG. 1). The information and commands for the menu shown on display 132 can be stored in ROM and loaded on the initial boot-up of information handling device 100, or upon selection of entertainment operating system 172.

In the illustrated embodiment, controls are shown for entertainment operating system 172 (FIG. 1). The user can select from digital video disk (DVD) player control 310 and compact disk (CD) player control 330. The DVD player and the CD player are preferably, but not necessarily, compact disk read-only memory (CD-ROM) and digital video disk read-only memory (DVD-ROM) units integrated in information handling device 100. The user can also select from stereo system controls 350. The stereo system controlled can be a separate unit being controlled by information handling device 100. Alternatively, stereo system controls can be used to control an integrated audio card or component in information handling device 100. Separate consumer appliances can also be controlled, such as through video cassette recorder (VCR) control 230 and television control 340.

The user can use display 132 to effect changes to the running operating system, as in system control 360. The user can select to switch to alternate operating systems, such as web browser operating system 174 (FIG. 1) or a general operating system. The user can decide to switch to an alternate operating system without disabling the currently running media handling devices 120. Alternatively, the user can also decide to shut down the running entertainment operating system. If the user selects to shut down the system, media handling devices 120 can be powered down or placed in a power saving mode. Furthermore, the running entertainment operating system 172 can be shut down. The devices under the control of the running operating system can be released and data left in random access memory (RAM) 150 (FIG. 1) can be cleared. Alternatively, the current settings of entertainment operating system 172 can be stored, allowing another operating system to be loaded and/or run concurrently with entertainment operating system 172.

The preceding descriptions have shown embodiments of the present invention used to control media handling devices and web browsing components through the use of ROM-based operating systems in a media handling device. Other devices and/or components can be controlled in addition to or in place of those described, such as home security systems and household lighting. The location of the alternate operating systems is also not limited to ROM or RAM; mass storage devices may also be employed as desired without departing from the present scope of the invention. Furthermore, any plurality of operating systems can be integrated into the information handling device for any specialized tasks required. It should now be appreciated by those skilled in the art that the present invention has the advantage that specialized tasks can be performed faster and more efficiently in an information handling device by running a specialized operating system to control specialized appliances.

Furthermore, the various components present in the present application may be implemented using a data processor, or a plurality of data processors. Such a data processor may be a microprocessor, microcontroller, microcomputer, digital signal processor, state machine, logic circuitry, and/or any device that manipulates digital information based on operational instruction, or in a predefined manner. Generally, the various functions, and systems represented by block diagrams are readily implemented by one of ordinary skill in the art using one or more of the implementation techniques listed above.

When data processor for issuing instructions is used, the instruction may be stored in memory. Such a memory may be a single memory device or a plurality of memory devices. Such a memory device may be read-only memory device, random access memory device, magnetic tape memory, floppy disk memory, hard drive memory, external tape, and/or any device that stores digital information. Note that when the data processor implements one or more of its functions via a state machine or logic circuitry, the memory storing the corresponding instructions may e embedded within the circuitry comprising of a state machine and/or logic circuitry, or it may be unnecessary because the function is performed using combinational logic.

In the preceding detailed description of the preferred embodiments, reference has been made to the accompanying drawings which form a part thereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical, chemical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined only by the appended claims.

What is claimed is:

1. A method comprising:
providing a plurality of operating systems on a single information handling device, the plurality of operating systems including an entertainment operating system to control the information handling device to operate a media playing device, and a general operating system to perform general information handling tasks;
executing the entertainment operating system to control the media playing device, wherein the entertainment operating system is independent of the general operating system; and
executing the general operating system to control the information handling device to perform general information handling tasks.

2. The method as in claim 1, further including switching between operating systems.

3. The method as in claim 2, wherein switching includes discontinuing the execution of one operating system prior to executing another operating system.

4. The method as in claim 2, wherein switching includes executing two or more of the plurality of operating systems concurrently.

5. The method as in claim 1, wherein:
executing the entertainment operating system includes reading the entertainment operating system from a non-volatile memory circuit; and
executing the general operating system includes reading the general operating system from a mass storage device.

6. The method as in claim 5, wherein the mass storage device includes a hard drive.

7. The method as in claim 5, wherein reading the entertainment operating system from the non-volatile memory circuit occurs substantially quicker than reading the general operating system from the mass storage device.

8. The method as in claim 5, wherein reading the entertainment operating system occurs at a substantially faster rate than reading the general operating system.

9. The method as in claim 1, wherein executing includes checking for resource conflicts.

10. An information handling system comprising:
a data processor;
a bios to provide initial processor control;
a memory coupled to said processor;
a communications interface; and
a plurality of operating systems to be executed by said processor, said plurality of operating systems including:
a general operating system capable of performing general information handling tasks; and
an entertainment operating system capable of controlling, through said communications interface, at least one media device, wherein said entertainment operating system is independent of said general operating system.

11. The system as in claim 10, wherein the said non-volatile memory circuit includes a read-only memory circuit.

12. The system as in claim 10, wherein said bios is to control which of said plurality of operating systems is executed.

13. The system as in claim 10, wherein:
said memory includes random access memory and read-only memory; and
said information handling system further includes a mass storage medium.

14. The system as in claim 13, wherein:
said general operating system is stored in said mass storage medium; and
said entertainment operating system is stored in said read-only memory.

15. The system as in claim 10, further including one or more appliances media devices to be coupled to said at least one communications interface.

16. The system as in claim 15, wherein said one or more appliances media devices are to be coupled to said communications interface via a network.

17. The system as in claim 10, wherein said one or more media devices are media handling systems.

18. The system as in claim 17, wherein said one or more media handling systems include at least one of an audio device and a visual device.

19. The system as in claim 10, wherein said communications interface is a wireless interface.

20. The system as in claim 10, wherein said communications interface is an electrical interface.

21. The system as in claim 10, wherein a resource conflict check is performed when said operating systems are executed.

22. A computer readable medium tangibly embodying a plurality of instructions, said plurality of instructions including:
instructions to implement an entertainment operating system on a general purpose information handling system;
said information handling system to perform general information handling tasks using a general operating system;
said entertainment operating system to control at least one media device, wherein said entertainment operating system is independent of said general operating system.

23. The computer readable medium as in claim 22, wherein said plurality of instructions further includes instructions to control which of said operating systems is executed.

24. The computer readable medium as in claim 22, wherein execution of said general operating system is terminated before switching to said entertainment operating system.

25. The computer readable medium as in claim 22, wherein execution of said entertainment operating system is terminated before switching to said general operating system.

26. The computer readable medium as in claim 22, wherein said general operating system and said entertainment operating system are executed concurrently.

27. The computer readable medium as in claim 22, wherein said at least one media device is a media handling system.

28. The computer readable medium as in claim 27, wherein said at least one media handling system includes at least one of an audio device and a visual device.

29. The computer readable medium as in claim 22, wherein said plurality of instructions further includes instructions to check for resource conflicts.

30. The method of claim 29, wherein the hard drive is stopped by being placed in at least one of a shutdown mode and a standby mode.

31. A method comprising:
executing an entertainment operating system on a single information handling device, the entertainment operating system to control the information handling device to operate a media device;
executing a general operating system on the single information handling device, the general operating system to perform general information handling tasks; and
wherein executing the entertainment operating system and executing the general operating system occurs concurrently.

32. The method of claim 31 wherein executing the general operating system includes checking for resource conflicts.

33. The method of claim 31, further comprising storing system settings associated with the entertainment operating system in memory while the entertainment operating system is running.

34. The method of claim 31, wherein the entertainment operating system is loaded from a read only memory and wherein a hard drive storing the general operating system is placed in at least one of a shutdown and a standby mode.

35. The method of claim 31, wherein the entertainment operating system is selected in response to a button on the media device being pressed by a user.

36. A method comprising:
executing an entertainment operating system on an information handling device, the entertainment operating system to control the information handling device to operate a compact disk player; and
executing a general operating system on the information handling device, the general operating system to perform general information handling tasks;
wherein the entertainment operating system is stored within non-volatile memory.

37. The method of claim 36, further comprising loading the entertainment operating system from the non-volatile memory to a random access memory (RAM) to enable those components of the information handling device needed to control the compact disk player.

38. The method of claim 36, wherein the entertainment operating system further controls a digital video disk (DVD) player.

39. The method of claim 36, further comprising placing a hard drive within the information handling device in a shut down or standby mode while the entertainment operating system is executed from the non-volatile memory.

40. The method of claim 36, wherein the entertainment operating system further controls at least one of a video cassette recorder, a television, and a stereo system.

41. The method of claim 36, wherein the information handling system is coupled to a home theater system via a network and wherein the entertainment operating system is used to control the home theater system.

42. The method of claim 36, wherein the compact disk player is integrated as part of the information handling system.

43. The method of claim 41, wherein the home theater includes at least one networked audio receiver to adjust audio speakers within a residence.

44. The method of claim 36, further comprising storing data associated with the entertainment operating system in a random access memory of the information handling system.

45. The method of claim 44, further comprising shutting down the entertainment operating system and removing the data associated with the entertainment operating system from the random access memory.

46. The method of claim 36, wherein the entertainment operating system further controls consumer appliances selected from refrigerators, home ovens, cloths washers, and home security systems.

47. The method of claim 36, wherein a second non-volatile memory is accessed by a central processor within the information handling system in response to a user request to use the general operating system.

48. The method of claim 36, further comprising performing a resource conflict check between the general operating system and the entertainment operating system prior to executing the entertainment operating system.

49. The method of claim 48, further comprising negotiating for use of potentially conflicting resources between the general operating system and the entertainment operating system.

50. The method of claim 36, wherein the entertainment operating system is loadable from the non-volatile memory into local random access memory more quickly than the general operating system can be loaded from a hard drive to the local random access memory.

51. A method comprising:
receiving a user selection of a specific media device to be controlled by an information handling system;
determining whether an entertainment operating system has been loaded into a memory of the information handling system, the entertainment operating system configured to control the specific media device; and
when the currently running operating system of the information handling system is a general operating system rather than the entertainment operating system, loading from a non-volatile memory and transferring operating control from the general operating system to the entertainment operating system within the information handling system to control the specific media device.

52. The method of claim 51, wherein the specific media device is a digital video disk (DVD) player.

53. The method of claim 51, wherein the specific media device is a compact disk (CD) player.

54. The method of claim 51, further comprising providing a display to allow a user to monitor and select controls for the specific media device.

55. The method of claim 54, wherein the specific media device is powered down in response to a user request made using the information handling system.

56. A computing and information handling system comprising:
a first non-volatile memory;
a second non-volatile memory including an entertainment operating system;
a remote storage device including a general computer operating system;
a random access memory;
a central processing unit responsive to the first non-volatile memory, the second non-volatile memory, the random access memory, and the remote storage device; and
a media device interface to control at least one media device.

57. The computing and information handling system of claim 51, further comprising a display device, the display device responsive to the entertainment operating system and configured to display a media device control screen, the media device control screen including a first set of control icons for control of a digital video disk player and a second set of control icons for control of a compact disk player.

58. The computing and information handling system of claim 57, wherein the media device control screen further includes a third set of control icons to control a television and a fourth set of control icons to control an audio device.

59. The system of claim 56, further comprising a communications interface coupled to a public computing network and coupled via a private network to a home theater system, the communications interface responsive to the central processing unit.

60. The system of claim 56, wherein the media device interface is an input/output interface coupled to a plurality of external media devices including a compact disk player and a digital video disk player.

61. The system of claim 56, wherein the entertainment operating system is loadable from the second non-volatile memory into the random access memory more quickly than the general operating system can be loaded from the hard drive to the random access memory.

62. The system of claim 56, wherein one of the entertainment operating system and the general operating system may be selected for execution by the central processing unit.

63. The system of claim 62, wherein the entertainment operating system is initially running to control the media device and wherein upon a user request, the general computing operating system is subsequently executed by the central processing unit.

64. The system of claim 63, wherein the general computer operating system is used to perform a computing task.
